(19) United States
(12) Patent Application Publication
(10) Pub. No.: US 2018/0345307 A1
(43) Pub. Date: Dec. 6, 2018

(54) METHOD FOR PROVIDING FILTER MODULES, COMPUTER PROGRAM PRODUCT, AND APPARATUS FOR PROCESS MANAGEMENT

(71) Applicant: EISENMANN SE, Böblingen (DE)

(72) Inventors: Herbert Schulze, Aidlingen (DE); Svenja Vetter, Neustetten (DE)

(21) Appl. No.: 15/778,731

(22) PCT Filed: Nov. 9, 2016
(86) PCT No.: PCT/EP2016/077032

§ 371 Date: May 24, 2018

(30) Foreign Application Priority Data
Nov. 25, 2015 (DE) 10 2015 015 234.3

(51) Int. Cl. B05B 14/43; G05B 15/02; G06Q 50/04

(52) U.S. Cl. CPC B05B 14/43; G06Q 50/04; G05B 15/02

(57) ABSTRACT

A method for providing filter modules for a surface treatment system, wherein input data is captured by a data processing device, wherein at least application data of the surface treatment system is used as input data, and wherein one or more pieces of output data relating to the provision of at least one filter module for the surface treatment system is determined using the input data. A computer program product having program code for carrying out the method when the computer program product is stored on a computer-readable data storage device or runs on a data processing device, and to an apparatus for process management having a data processing device, which is designed to carry out the method. Linking of the process of providing filter modules and the process of surface treatment of objects is enabled, whereby efficiency and quality can be improved in both processes.

The invention relates to a method for providing filter modules for a surface treatment plant.

The invention also relates to a computer program product having program code means for carrying out such a method.

The invention furthermore relates to an apparatus for process management for the provision of filter modules for a surface treatment plant.

For example during the manual or automatic application of paints onto objects, a part of the flow of the paint, which in general contains both solids and/or binders as well as solvents, is not applied onto the object. This part of the flow is referred to in the technical field as “overspray”. In what follows, the terms overspray, overspray particles and overspray solids are to be understood in the sense of a disperse system, such as an emulsion or suspension or a combination thereof. The overspray is picked up by an air flow in a treatment booth, for example a painting booth, and fed to a separator, so that the air can be fed back into the treatment booth after suitable conditioning. Optionally, this conditioned air may be mixed with fresh air.

Particularly in systems with relatively high paint consumption, for example in systems for painting of vehicle bodies, in the known way wet separator systems on the one hand, or electrostatically operating dry separators on the other hand, are preferably used. In known wet separators, a comparatively large amount of energy is needed for circulating the very large amounts of water necessary. Processing of the washing water is cost-intensive because of the high use of chemicals that bind and unbond paint, and because of the paint slurry disposal.

Furthermore, the air absorbs a very large amount of moisture because of the intensive contact with the washing water, which in circulated-air operation in turn entails a high energy consumption for the air processing. In electrostatically operating dry separators, the paint overspray needs to be removed continuously from the separating surfaces, which is usually associated with structurally very elaborate measures, and may be correspondingly susceptible to problems. Furthermore, energy outlay in such separators is comparatively high.

As alternatives to current stationary wet and dry separator systems, which may also operate electrostatically, systems with replaceable single-use separating units are also used, which are replaced with fresh filter modules after a threshold load of overspray is reached, and disposed of or possibly recycled. The processing and/or disposal of such separating units may be more acceptable in terms of energy and in relation to the resources required than the outlay in a wet separator or an electrostatically operating separating apparatus.

An apparatus for removing process air loaded with overspray is known from DE 10 2012 004 704 A1, in which at least one replaceable through-flow module, which has an inlet opening and an outlet opening and on the inner faces of which overspray can be deposited, can be arranged in the flow path of the process air loaded with overspray, means being provided by which the at least one through-flow module can be replaced with a fresh through-flow module after a threshold load of overspray is reached. DE 10 2012 004 704 A1 also describes a plant, having such an apparatus, for coating objects.

DE 10 2011 117 667 A1 discloses a filter module for separating overspray from the overspray-loaded booth air of coating plants, in particular painting plants, having a filter housing which delimits a filter space through which overspray-loaded booth air can be directed in a main flow direction. A multiplicity of separating elements made of a separating material that is permeable for the booth air is arranged in the filter space, in such a way that a flow labyrinth is formed between the separating elements. A separating apparatus and a plant, having such a filter module, for coating objects are furthermore specified in DE 10 2011 117 667 A1.

DE 10 2013 011 107 A1 describes a method for operating a surface treatment plant, in which overspray, which is formed in one or more coating booths, is taken up by an air flow and fed to at least one single-use separating unit, in which overspray is deposited and which, as a loaded single-use separating unit, is replaced with an empty single-use separating unit after a threshold load of overspray is reached.

The object of the present invention is to specify an improved method for providing filter modules for a surface treatment plant.

This object is achieved by a method of the type mentioned in the introduction, wherein input data are acquired by means of a data processing device, wherein at least application data of the surface treatment plant are used as input data, and wherein one or more output data, which relate to the provision of at least one filter module for the surface treatment plant, are determined by using the input data. In this way, the filter modules can be provided in accordance with the type of surface treatment and the demand. Mutual tuning of the processes is made possible, so that the efficiency in both processes can be increased.

In order to further increase the efficiency overall, input data may be stored, at least parts of the stored input data being used in order to determine predictive output data.

Provision data, which relate to the provision of one or more filter modules intended for use in the surface treatment plant, may advantageously be used as input data.

Preferably, processing data of a processing plant for loaded filter modules may be used as input data.

For example in order to improve the processes in the surface treatment plant, it may be advantageous if output data, which relate to an application process in at least one treatment booth of the surface treatment plant, are determined.

It may be expedient if output data, which specify the instant of the provision of a filter module for a treatment booth in the surface treatment plant, are determined.

For example with a view to provision of the filter modules according to requirements, it may be favorable if output data, which are transmitted to a manufacturing plant for filter modules, are determined.

Advantageously, output data, which are transmitted to a disposal device, may be determined.

The object of the invention is also achieved by a computer program product having program code means for carrying out a method according to the invention or one of its configurations when the computer program product is stored on a computer-readable storage medium or runs on a data processing device. The corresponding advantages are obtained in a similar way to those of the method.

The object of the invention is also achieved by an apparatus for process management for the provision of filter modules for a surface treatment plant, the apparatus having a data processing device which is configured for carrying out a method according to the invention or one of its configurations.

It is favorable if a measuring apparatus, by means of which operating parameters of the surface treatment plant are determined, is provided.

Further advantageous configurations of the invention may be found in the following description. In the latter, exemplary embodiments of the invention will be explained in more detail with the aid of the drawing, without being restricted thereto. In a simplified schematic representation:

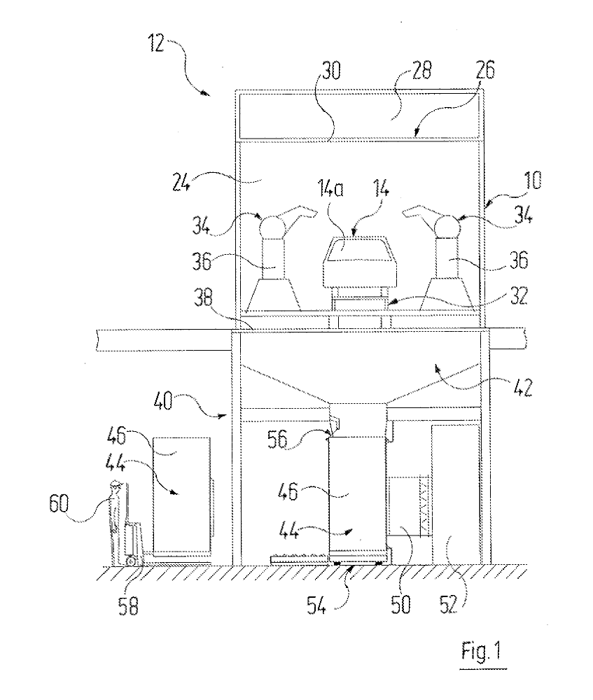

FIG. 1 shows a painting booth having a separating apparatus for overspray;

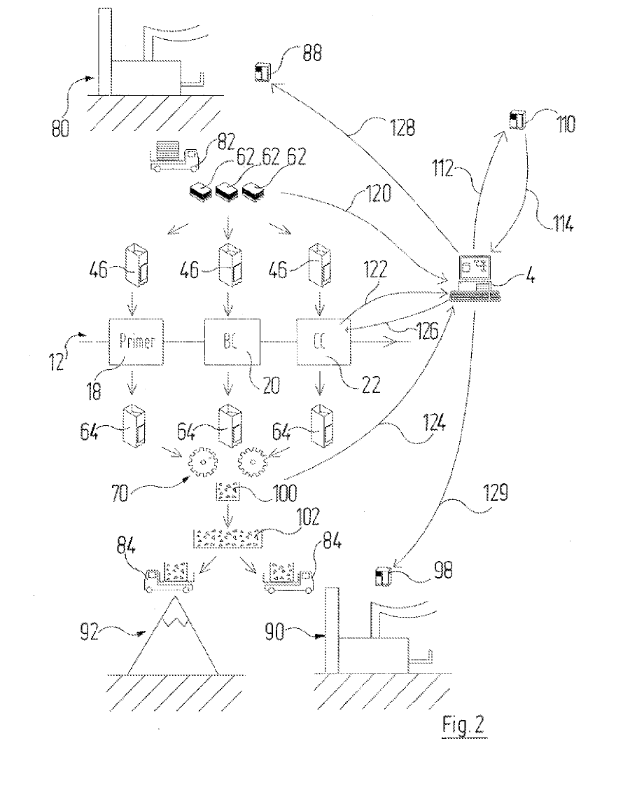

FIG. 2 shows an overview diagram of the use of filter modules for a surface treatment plant and of the disposal of loaded filter modules;

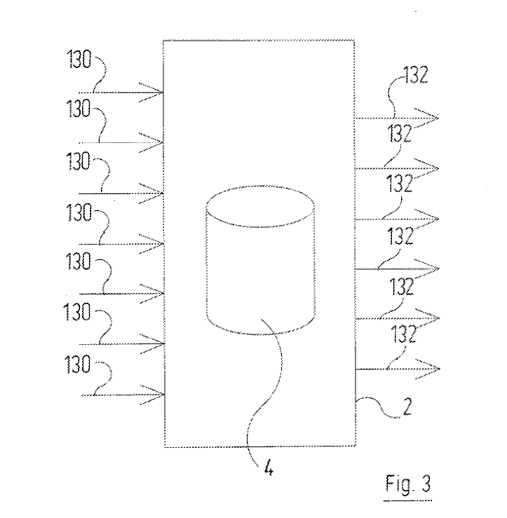

FIG. 3 shows an apparatus for process management for the supply and disposal of filter modules.

FIG. 1 shows a treatment booth 10 of a surface treatment plant 12 for objects 14, in which case the treatment booth 10 may for example be configured as a coating booth for coating objects 14. In the example shown, the coating booth is configured as a painting booth for objects 14, for example with vehicle bodies 14a or parts thereof being painted in the painting booth.

The treatment booth 10 configured as a coating booth has a coating tunnel 24 with a roof 26, which may be configured in the usual way as the lower boundary of an air delivery space 28 having a filter roof 30. The coating tunnel 24 is arranged above a plant region 40.

The objects 14 are transported with a conveyor system 32, arranged in the coating tunnel 24, from the entry side of the coating tunnel 24 to its exit side. Thus, for example, vehicle bodies 14a may be conveyed in a continuous or intermittent movement through the interior of the coating tunnel 24 by means of a conveyor system 32 known per se.

Arranged inside the coating tunnel 24, there are application devices 34 which, for example, may be configured in the form of multiaxial application robots 36, as are likewise known per se. By means of the application robots 36, the objects 14 to be treated, in the example shown the vehicle bodies 14a, can be coated with a corresponding material.

During the coating process, air flows from the air delivery space 28 through the coating tunnel 24 to the plant region 40, the air taking up and carrying with it overspray present in the coating tunnel 24, for example paint overspray.

In the example shown, the bottom of the coating tunnel 24 is essentially formed by a grating 38 that can be walked on. The coating tunnel 24 is open downward through the grating 38 to the plant region 40 arranged underneath. In this way, the air from the coating tunnel 24 can flow into the plant region 40 arranged underneath, in which particles, in particular overspray, entrained by the booth air are removed from the booth air.

This air loaded with overspray is guided with the aid of an air guide device 42 to one or more single-use separating units 44, which in the present exemplary embodiment are configured in the form of one or more single-use filter modules 46. Reference will be made below to filter modules, although the comments regarding this correspondingly apply in sense generally and also for single-use separating units 44, which may be configured in a different way than the filter modules 46 described.

During operation, each filter module 46 is connected in terms of flow and releasably to the air guide device 42. In the filter module 46, the booth air flows through a filter unit (not represented in detail in the drawing), on which the paint overspray is deposited. The filter module 46 may, for example, be configured as a separating filter or as an inertial filter, or as a combination thereof. Overall, each single-use separating unit 44 is configured as a replaceable component.

The booth air, from which overspray particles have at least substantially been removed, flows out of the filter module 46 into a channel 50, through which it enters a collection flow channel 52.

The booth air is delivered through the collection flow channel 52 to further processing and conditioning, and after this is guided in a circuit (not shown separately here) back into the air delivery space 28, from which it again flows into the coating tunnel 24. If overspray has not yet been removed sufficiently from the booth air by the filter modules 46 provided, the filter modules 46 may be followed by further filter stages, to which the booth air is delivered and in which nonwoven filters or electrostatically operating separating filters, such as are known per se, are for example used. Optionally, one or more such further filter stages may also be integrated into the filter module 46.

In the present exemplary embodiment, the filter module 46 is arranged in its operating position on a balance 54. It is locked in its operating position by means of a latching device 56. In the present exemplary embodiment, the filter module 46 may be connected in terms of flow to the air guide device 42 or separated therefrom, by being moved in the horizontal direction. In general, however, the coupling and decoupling movements depend on the interaction of components.

Each filter module 46 is configured for absorbing a maximum amount of paint, i.e. for threshold loading with overspray, which depends on the design of the filter module 46 and the materials used for it. The amount of paint already absorbed can be recorded with the aid of the balance 54. As an alternative, for example, the threshold loading may be determined by means of a differential pressure determination. The greater the loading of the filter module 46 is, the greater the air resistance presented by the filter module 46 is.

When a filter module 46 has reached its maximum absorption capacity, the latching device 56 is released and the fully loaded filter module 46 is taken out of the lower plant region of the treatment booth 10. This may, for example, be done with the aid of a fork-lift truck 58, which is operated by a worker 60. To this end, the bottom region of the filter module 46 may be configured in its geometry and its dimensions as a standardized carrying structure, and for example according to the specification of the so-called EUR-pallet.

Before this, the flow connection of the filter module 46 to be replaced to the air guide device 42 is closed by means of a gate valve (not shown separately). After a loaded filter module 46 has then been removed, an empty filter module 46 is pushed into the operating position, in which it is tightly connected to the air guide device 42 in terms of flow, whereupon the latching device 54 is locked again. The gate valve of the air guide device 42 is brought back into an open position, so that the booth air flows through the newly positioned filter module 46.

Instead of an empty filter module 46, a partially loaded filter module 46 from an edge region, in which less overspray occurs, of the painting booth 12 may also be moved to the replacement position.

Measuring devices for recording operating parameters may be provided in the surface treatment plant 12. These include for example the air pressure, the temperature, the humidity and the downward air speed or the flow rate of the booth air.

FIG. 2 illustrates by way of example the provision and use of filter modules 46 for a surface treatment plant 12, and the disposal of loaded filter modules 64.

The filter modules 46, or individual parts thereof, are produced in one or more manufacturing plants 80 (only one of which is shown). The filter modules 46 are preferably configured as single-use filter modules, in which case a filter module 46 as a whole, including its filter unit (not represented in detail), may for example be made of a water-resistant recycling material.

In general terms, one component, a plurality of components or all components of the filter module 46 may be made of a water-resistant recycling material. For example, cellulose materials, such as optionally treated paper and pulp materials, corrugated cardboard, cardboards with standing corrugations, cardboards with a honeycomb structure or wound cardboards, but also other materials such as for example MDF materials, may be envisioned for this. The bottom region of the filter module 46 may also be formed separately by a EUR-pallet made of wood. Plastics, in particular polyethylene or polypropylene, may also be envisioned.

For use in a surface treatment plant 12, the filter modules are delivered by means of suitable transport means 82 from the manufacturing plant 80 to the surface treatment plant 12. In this case, the filter module 46 itself may be delivered as a modular construction kit 62 in individual parts, and be assembled before its use, for example at the site of the surface treatment plant 12. As an alternative, the filter module 46 may also be delivered fully constructed, or partially constructed.

For example, a filter module 46 may also be designed in such a way that it can be unfolded from a collapsed configuration.

A construction kit 62 of a filter module 46 has a volume which may be significantly less than the volume of the unfolded or constructed filter module 46. For example, filter module construction kits 62 or filter modules 46 ready for use may be taken to the surface treatment plant 12, or to the coating booth (see FIG. 1) in which the filter modules 46 are intended to be used. In the case of the filter module construction kits 62, the filter modules 46 are produced therefrom on site. The filter modules 46 may then, for example, be used in a surface treatment plant 12 in the manner described in connection with FIG. 1.

A surface treatment plant 12 may have one or more coating stations 18, 20, 22, which may respectively be equipped with one or more treatment booths 10 (see FIG. 1). The surface treatment plant 12 schematically outlined in FIG. 2, in which for example vehicle bodies 14a are surface-treated, has a first coating station 18 for applying primer or filler, a second coating station 20 for applying base paint or undercoat, and a third coating station 22 for applying topcoat or varnish.

In the coating booths 10 of the coating stations 18, 20, 22, the respective coating material is applied onto the objects 14, for example the vehicle bodies 14a (see FIG. 1). Before the objects to be painted reach such a coating booth 10, they may be cleaned and/or degreased, or subjected to a pretreatment configured in another way, in a pretreatment stations (not represented in detail).

After the threshold load is reached, the filter modules 64 which are then loaded are, for example as described in connection with FIG. 1, removed from the respective treatment booth 10 and disposed of, various types of recycling being possible. Thus, for example, the loaded filter modules 64 are loaded with different types of overspray depending on the treatment booth 10 from which they come.

After the end of the utilization phase of the filter modules 46, i.e. after their use in the surface treatment plant 12, the recycling phase in which the loaded filter modules 64 are disposed of begins.

The loaded filter modules 64 may be subjected to a processing treatment in a processing plant 70 in order to produce a processed material 100 which may subsequently be delivered to a recycling plant 90, or a dump 92. The processing plant 70 may be present on site or in the vicinity of the surface treatment plant 12, or may also be at a distance therefrom.

In the processing plant 70, the loaded filter modules 64 may be dried. Drying is in this case intended to mean all processes in which the absorbed overspray can be made to solidify, whether by expelling solvents or by crosslinking the coating substance. To this end, the overspray may for example be treated with electromagnetic radiation and/or, for example, thermally treated with hot air by means of blowers.

As an alternative or in addition, the filter modules 64 may be broken down in the processing plant 70, in which case they may for example be coarsely broken down or reduced in size. This may, for example, be done with a cutting device in which the individual filter modules are cut into relatively small filter parts. As an alternative or in addition, the filter modules 64 may for example be crushed in a pressing device to form a relatively small filter package.

As an alternative or in addition, the processing plant 70 may have a shredder station, in which the filter parts and/or the filter packages are processed with the aid of one or more shredding devices to form shredded material. Additives may in this case be admixed in order to modify and influence the consistency of the shredded material or its properties, in particular calorific value. Thus, for example, rock and wood materials in the form of flours, powders or dusts may be added both as binders and to increase the calorific value. The material of the loaded filter modules 64 may also be used as a carrier material for pastes or liquids, which are formed elsewhere as waste products and need to be disposed of or burned and for which further treatment is made difficult because of their consistency, for example paste-like or fluid.

Further and/or other processing treatments (not explained in detail here) may be carried out in the processing plant 70.

Depending on the configuration of the loaded filter modules 64, and for example depending on the type and amount of the absorbed overspray, a few or even only a single processing treatment may be carried out.

By means of the processing plant 70, a processed material 100 is obtained which may have different physical properties compared with the starting material in the form of the loaded filter modules 64. For example, the volume, the density, the structure, the consistency and/or the moisture content and the like may be modified and possibly adjusted in a controlled way by one or more processing treatments. The chemical properties of the processed material 100 may also be modified compared with the loaded filter modules 64. In particular, properties such as combustability, flashpoint, pH, adhesion capacity and the like may be mentioned in this context.

In the processing plant 70, the loaded filter modules 64 may be subjected to a common treatment, irrespective of the type of overspray with which they are loaded. For such processing, it is not important which coating station 18, 20, 22 the loaded filter modules 64 come from.

Processing according to type is also possible, with loaded filter modules 64 which come from the same or the same type of coating booths 10, so that the filter modules 64 are loaded with overspray of the same type, respectively being processed together in the processing plant 70.

The processing plant 70 may at least partially be integrated with the surface treatment plant 12. It is also possible for the processing plant 70 to be at least partially separated from the surface treatment plant 12. Separation and isolation of the individual constituents may also be carried out in the processing plant 70, so that suitable constituents of the loaded filter modules 64 can be delivered to material recycling. The remaining constituents which cannot be recycled or upgraded, may be delivered to a dump 92, or thermally reused.

The processed material 100 may be sorted, collected/and or temporarily stored before preparation for further disposal. The processed material 102 ready for disposal is preferably delivered by means of suitable transport means 84 to a recycling plant 90 or a dump 92.

In the recycling plant 90, energy- and resource-saving material recycling is carried out by thermal reuse and/or delivery of processed material 100, 102 to subsequent manufacturing processes. Energy recovered in the recycling plant 90 may, for example, be used for operating the surface treatment plant 12 and/or for operating the processing plant 70. Energy may for example be obtained by thermal reuse, for example by means of an incineration process. Recycling of processed material 100, 102 may also be carried out by its use in the production of new filter modules 46, for example in a manufacturing plant 80. The processed material 100, 102 may also be used in other processes, possibly after corresponding pretreatment.

Processed material 100, 102 may be stored in the dump 92. Other substances may possibly be processed together with processed material 100, 102 to be delivered to a dump, so that the substances can be disposed of more easily and in a more environmentally friendly way.

With the aid of a data processing device 4, data for the provision, use and/or disposal of the filter modules 46, or of the loaded filter modules 64, are collected and processed.

The data processing device 4 may, for example, be supplied with provision data 120 which relate to the scope of the filter modules 46 provided for use in the surface treatment plant 12. Provision data 120 may, in particular, relate to the number of filter modules 46 provided. The provision data 120 may also relate to the type, state and/or place of provision of the filter modules 46. Such provision data 120 may also relate to the allocation of the filter modules 46 provided to a coating station 18, 20, 22. The provision data 120 may also pertain to filter modules 46 in the form of construction kits 62.

The data processing device 4 may, for example, also be supplied with data relating to the one or more manufacturing plants 80, or data about filter modules 46 which are being manufactured and/or have been manufactured, and possibly also about corresponding construction kits 62. This is not represented in detail in FIG. 2 for the sake of better clarity.

The data processing device 4 may be supplied by one or more coating stations 18, 20, 22, for example with application data 122. Application data 122 may be data which relate to the application process in the coating station 18, 20, 22, for example relating to the type of paint used and/or the paint color. Application data 122 may also relate the nature or type of the object 14 to be coated (see FIG. 1), and for example denote a vehicle type or a variant of a vehicle type.

Application data 122 may also relate to the actual service life or residence time of a filter module 46 in a coating station 18, 20, 22. For example, the actual degree of loading of a filter module 46 may also be measured, for example with the aid of a balance 54 (see FIG. 1). The information relating to the degree of loading may be supplied to the data processing device 4 as application data 122.

The transmission of application data 122 may take place from one or more coating stations 18, 20, 22 and/or other parts of the surface treatment plant 12 to the data processing device 4. For better clarity, this is indicated by way of example in FIG. 2 only for the third coating station 22.

The data processing device 4 may, for example, be supplied with processing data 124 which relate to the scope and type of the processing of the loaded filter modules 64. Processing data 124 may relate to quantity information about loaded filter modules and/or about processed material 100, 102 in the processing plant 70. Processing data 124 may also relate to physical and/or chemical properties of the processed material 100, 102 and/or the loaded filter modules 64. Processing data 124 may also relate to process states of one or more processing operations and/or measurement data, in particular physical measurement data.

The data processing device 4 may, for example, also be supplied with data relating to the one or more recycling plants 90 and/or relating to the one or more dumps 92. This is not represented in detail in FIG. 2 for better clarity.

The data processing device 4 may, for example, also be supplied with data relating to the transport means 82, 84. This is likewise not represented in detail in FIG. 2 for better clarity.

The data supplied may be stored and processed in the data processing device 4. For example, the increase in the degree of loading of a filter module 46 may be determined as a function of one/or more application data 122 in the data processing device 4 by evaluating application data 122 over particular time intervals, for example from the introduction of a filter module 46 until its removal. For example, a service life of a filter module 46, dependent on a paint type and/or a paint color, may be determined in the data processing device 4. The service life of a filter module 46 may possibly also be determined as a function of data which, for example, relate to a vehicle type.

The data processing device 4 may be configured for exchanging actual data 112 and setpoint data 114 with a production planning system 110, in which case the production planning system 110 may be configured as part of a so-called ERP system.

The data processing device 4 may determine instructions for the surface treatment plant 12. From the data processing device 4, such instructions may be transmitted as instruction data 126 to the surface treatment plant 12. Such instructions may, for example, relate to the replacement instant of a filter module 46 in a coating station 18, 20, 22 of the surface treatment plant 12. For the sake of better clarity, the transmission of instruction data 126 to the surface treatment plant 12 is indicated by way of example only for the third coating station 22.

The data processing device 4 may determine demand data 128, which may for example relate to the manufacture of filter modules 46. The demand data 128 may, for example, be transmitted to a computing device 88 of the manufacturing plant 80. In this way, for example, filter modules 64 and/or construction kits 62 for filter modules may be requested for provision, and/or their production may be influenced.

The data processing device 4 may determine disposal data 129, which may for example relate to the disposal of loaded filter modules 64. The disposal data 129 may for example be transmitted to a computing device 98 of a disposal device, for example a recycling store 90 or a dump 92. In this way, for example, disposal capacities may be requested and/or the delivery of processed material 100, 102 may be announced. It is possible that processes taking place in the recycling store 90 are influenced with the aid of disposal data 129.

FIG. 3 shows a highly simplified representation of an apparatus 2 for process management for the supply of a surface treatment plant 12 with filter modules 46. This apparatus 2 may also be configured for process management for the disposal of filter modules 46, or loaded filter modules 64.

The apparatus 2 shown in FIG. 3 is supplied with input data 130, which may for example at least partially be stored in the data processing device 4 (see also FIG. 2). Input data 130 and/or parts thereof may be processed in the data processing device 4. The apparatus 2 shown provides output data 132, these output data 132 being determined at least partially by the data processing device 4. In order to determine output data 132, the data processing device 4 may use one or more input data 130 and/or optionally further data.

Input data 130 may for example be application data 122 described in connection with FIG. 2, which are supplied to the data processing device 4 by the surface treatment plant 12. Accordingly, input data 130 may relate to the type and/or configuration of the object 14 to be treated in a surface treatment plant 12. Input data 130 may also denote the type and/or configuration of a coating material, for example a paint type and/or a paint color. Input data 130 may also relate to the amount of overspray which there is in one or more particular filter modules 46 in a surface treatment plant 12. Input data 130 may also be one or more application parameters of the surface treatment, for example temperature, pressure, humidity, application duration.

A surface treatment plant 12 also comprises components which are arranged at a distance from the actual treatment booth. In the case of a painting plant, these are for example components of the paint supply, such as paint containers, conveyor means for media and the like. These components may also be equipped with measuring devices, which may transmit corresponding operating parameters to the system.

Input data 130, which are supplied to the apparatus 2 for process management by the surface treatment plant 12 and/or by other plants and/or plant parts, may for example also relate to processes which are upstream or downstream of the processes in the surface treatment plant 12. For the example of the painting process of a vehicle body 14a, which is painted in a painting booth of a surface treatment plant 12, an upstream process may for example relate to the body assembly, and a downstream process may for example relate to the fitting of interior or exterior parts and/or the chassis mounting.

With the aid of the data processing device 4, for example, a service life end to be expected for a filter module 46 may be determined. As an alternative or in addition, an optimal service life end of a filter module 46 may for example also be determined. Accordingly, information and/or instructions may be provided in the form of output data 132.

The apparatus 2 for process management may for example deliver output data 132 relating to the manufacture, the provision and/or the transport of filter modules 46. The filter modules 46 may in this case optionally also be in the form of construction kits. Such output data 132 may, for example, be used for process control and/or for planning in a manufacturing plant 80.

Output data 132 of the apparatus 2 for process management may also relate to the provision of filter modules 46 inside a surface treatment plant 12, and in this regard may be used for process control and/or for planning. This means, for example, that the system knows how many filter modules there are in each loading state in the plant. On the basis of this knowledge, the planned treatment sequence of objects can be correlated with the capacity of the filter modules, so that the treatment sequence can be modified in such a way that, on the one hand, the capacity of a filter module is substantially utilized, and on the other hand an imminent replacement of one or more filter modules may for example take place in periods of time in which there is a treatment pause dictated by production. Subsequent production steps are also taken into account in the planning. As an alternative, the planning may also lead to the result that one or more filter modules are replaced before reaching full loading, in order to ensure an effective throughput of the surface treatment plant.

Output data 132 of the apparatus 2 for process management may relate to the application process in the surface treatment plant 12, and in this regard be used for process control and/or for planning. Output data 132 which relate to the application process in the surface treatment plant 12 may, for example, relate to properties of an application means used.

Output data 132 of the apparatus 2 for process management may also relate to the disposal of loaded filter modules 64. Such output data 132 may for example be used in a processing plant 70, for example for process control and/or for planning. It is also possible to use such output data 132 in a recycling plant 90. Furthermore, it is also possible to use such output data 132 in a dump. Output data 132 which relate to the disposal of loaded filter modules 64 may, for example, be used for capacity planning in the cases mentioned.

The apparatus 2 for process management, with the data processing device 4, may link specific parameter data of the surface treatment with data that relate to the filter modules 46. The data to be linked may be supplied to the data processing device as input data 130, stored in the data processing device 4, supplied thereto in another way and/or determined in the data processing device 4. By linking the data, possibilities of process optimization are provided in terms of the provision, logistics and/or disposal of filter modules 46. Instructions and/or predictions may be derived, and these may be output in the form of output data 132.

Specific parameter data of the surface treatment, in the case of painting a vehicle body 14a, may for example be vehicle type, hue and/or paint type. Data relating to the filter modules 46 may, for example, relate to the configuration and/or the service life of filter modules 46. In addition to the linking of specific parameter data of the surface treatment with data that relate to the filter modules 46, further data, for example instructions of a manufacturing process, for example of vehicle production, may also be incorporated in the apparatus 2 for process management. The output data 132 may be used in order to optimize the manufacturing process, and may for example be used to control the manufacturing process.

The data determined in the data processing device 4, for example one or more output data 132, may relate to the provision of a filter module 46 for the surface treatment plant 12. Such output data 132 may be determined in a forward-looking fashion, or predictively, in which case data stored in the data processing device 4 may for example be evaluated. In order to determine predictive output data 132, statistical methods may for example be used. It is possible to determine predictive output data 132 by means of methods of artificial intelligence, for example neural networks.

On the basis of output data 132, for example, a filter module 46 adapted to a painting process in the surface treatment plant 12 may be provided in time for the change. Such output data 132 may, for example, be supplied as instruction data 126 (see FIG. 2) to the surface treatment plant 12, and optionally used there. With the aid of the data processing device 4, it is possible to control the storage and/or the provision of the filter modules 46, or to store the data relating thereto. It is also possible to plan or initiate the disposal of a loaded filter module 64 by using such output data 132.

Groups of data which may be used as input data 130 and/or as output data 132 will furthermore be described by way of example below.

One group of data which may be used as input data 130 and/or as output data 132 relates to the provision of filter modules 46, in which case such data may for example describe a type, a quantity indication or an instant. Such data may, for example, describe the stock of and/or demand for filter modules 46. Such data may, for example, be used for provision according to demand and/or for optimization of the stockholding.

Another group of data which may be used as input data 130 and/or as output data 132 relates to the surface treatment, in which case such data may for example relate to the overspray, for example amount of overspray per object 14, for example per vehicle body 14a (see also FIG. 1). In this context, it should be mentioned that an increase in weight of the filter module 46 used, or a change in the differential pressure mentioned above, allows conclusions about the overspray formed. Data relating to the overspray may be used to adjust painting parameters. In this context, it should be mentioned that, from data relating to the overspray, particularly favorable or unfavorable painting parameters may be identified for example and/or conclusions about the quality of paint batches are possible for example. This may then be used for improved control of the surface treatment plant 12.

Another group of data which may be used as input data 130 and/or as output data 132 relates to the disposal of loaded filter modules 64. Such data may be used for optimization, for example for time optimization, of the transporting away of loaded filter modules 64 and/or planning of processing and/or recycling. The data determined and/or stored in the data processing device 4 may be used to improve the disposal procedure. For example, it is possible to ensure that, for a recycling plant 90 in which loaded filter modules 64 or processed material 100, 102 thereof are used as starting material for a recycling process, the starting material is provided in the required quality. A prerequisite for this may, for example, be that the starting material is provided in a constant composition for the recycling process.

Part of the disposal of loaded filter modules 64 may also be understood as the separation, collection and/or storage of processed material 100, 102.

A concept on which the invention is based may be summarized as follows: The present invention relates to a method for providing filter modules 46 for a surface treatment plant 12, wherein input data 130 are acquired by means of a data processing device 4, wherein at least application data 122 of the surface treatment plant 12 are used as input data 130, and wherein one or more output data 132, which relate to the provision of at least one filter module for the surface treatment plant 12, are determined by using the input data 130. The invention also relates to a computer program product having program code means for carrying out the method when the computer program product is stored on a computer-readable storage medium or runs on a data processing device 4, and to an apparatus 2 for process management having a data processing device 4 which is configured for carrying out the method. The invention makes it possible for the process of the provision of filter modules 46 and the process of the surface treatment of objects 14 to be linked together in terms of process control, so that the efficiency and the quality can be improved in both processes.

All data obtained may be managed in a network, so that those from surface treatment plants at different locations with different operating parameters and treatment media used may be compared with one another and statistically recorded.

By the data exchange inside the plant, it is possible to operate the entire system predictively. Thus, an imminent change of a filter module 46 may be optically and/or acoustically displayed early on, so that a worker can start with the required provision measures in time. In the case of a plant operating automatically or at least semi-automatically, the procedures taking place in a correspondingly automated way may be initiated early on.

What is claimed is:

1. A method for providing filter modules for a surface treatment plant comprising the steps of:
(a) acquiring input data by means of a data processing device,
(b) using at least application data of a surface treatment plant as input data, and
(c) determining one or more output data, which relate to the provision of at least one filter module for the surface treatment plant, by using the input data.

2. The method as claimed in claim 1, wherein input data are stored, at least parts of the stored input data being used in order to determine predictive output data.

3. The method as claimed in claim 1, wherein provision data, which relate to the provision of one or more filter modules (46) intended for use in the surface treatment plant (12), are used as input data (130).

4. The method as claimed in claim 1, wherein processing data of a processing plant for loaded filter modules are used as input data.

5. The method as claimed in claim 1, wherein output data, which relate to an application process in at least one treatment booth of the surface treatment plant, are determined.

6. The method as claimed in claim 1, wherein output data, which specify the instant of the provision of a filter module for a treatment booth in the surface treatment plant, are determined.

7. The method as claimed in claim 1, wherein output data, which are transmitted to a manufacturing plant for filter modules, are determined.

8. The method as claimed in claim 1, wherein output data, which are transmitted to a disposal device, are determined.

9. A computer program product having program code means for carrying out a method as claimed in claim 1 when the computer program product is stored on a computer-readable storage medium or runs on a data processing device.

10. An apparatus for process management for the provision of filter modules for a surface treatment plant, having a data processing device which is configured for carrying out a method as claimed in claim 1.

11. The apparatus as claimed in claim 10, further comprising a measuring apparatus, by means of which operating parameters of the surface treatment plant are determined.
